(19) United States
(12) Patent Application Publication
(10) Pub. No.: US 2021/0041712 A1
(43) Pub. Date: Feb. 11, 2021

(54) ELECTRONICALLY-STEERABLE OPTICAL SENSOR AND METHOD AND SYSTEM FOR USING THE SAME

(71) Applicant: GM GLOBAL TECHNOLOGY OPERATIONS LLC, Detroit, MI (US)

(72) Inventors: Igal Bilik, REHOVOT (IL); Tzvi Philipp, Beit Shemesh (IL); Shahar Villeval, TEL AVIV (IL); Jeremy A. Salinger, Southfield, MI (US); Shuqing Zeng, STERLING HEIGHTS, MI (US)

(21) Appl. No.: 16/531,982

(22) Filed: Aug. 5, 2019

(51) Int. Cl. G02B 27/28; G02B 26/08; G02B 3/00

(52) U.S. Cl. CPC G02B 27/283; G02B 26/0833; G02F 2001/133638; G05D 2201/02; G02B 3/0006

(57) ABSTRACT

A system and method for obtaining an overall image that is constructed from multiple sub-images. The method includes: capturing a first sub-image having a first sub-image field of view using an image sensor of an electronically-steerable optical sensor; after capturing the first sub-image, steering light received at the electronically-steerable optical sensor using an electronically-controllable light-steering mechanism of the electronically-steerable optical sensor so as to obtain a second sub-image field of view; capturing a second sub-image having the second sub-image field of view using the image sensor of the electronically-steerable optical sensor; and combining the first sub-image and the second sub-image so as to obtain the overall image.

### INTRODUCTION

The exemplary embodiments described herein generally relate to optical sensors such as cameras and, more particularly, to an electronically-steerable optical sensor that can capture images having a field of view that can be electronically controlled.

Vehicles and devices having electronics may come equipped with a variety of sensors and cameras that are mounted on the vehicle, such as a rear-view or forward-view camera. These cameras may be configured to capture a field of view that is relatively wide (e.g., 90°). However, when the field of view is increased in size, the resolution of the camera may be reduced as a trade-off, or other factors may be negatively impacted, such as the price of the camera and/or its various components, the size of the camera, etc. Cameras and/or image sensors used as a part of other, non-vehicle systems experience a similar trade-off of resolution and the breadth of the field of view.

Thus, it may be desirable to provide an image sensor, such as a camera, that is able to capture high-resolution images while maintaining a relatively wide field of view (FOV).

### SUMMARY

According to one aspect, there is provided a method for obtaining an overall image that is constructed from multiple sub-images. The method includes: capturing a first sub-image having a first sub-image field of view using an image sensor of an electronically-steerable optical sensor; after capturing the first sub-image, steering light received at the electronically-steerable optical sensor using an electronically-controllable light-steering mechanism of the electronically-steerable optical sensor so as to obtain a second sub-image field of view; capturing a second sub-image having the second sub-image field of view using the image sensor of the electronically-steerable optical sensor; and combining the first sub-image and the second sub-image so as to obtain the overall image.

According to various embodiments, the method may further include any one of the following features or any technically-feasible combination of some or all of these features:
the electronically-controllable light-steering mechanism includes a liquid crystal material;
the steering step includes controlling application of voltage to the liquid crystal material so as to steer the light in a particular manner;
the liquid crystal material is an active half-waveplate;
the electronically-controllable light-steering mechanism includes a polarization grating arranged next to the active half-waveplate in a manner such that incoming light first passes through the active half-waveplate and then through the polarization grating;
the electronically-controllable light-steering mechanism includes a first liquid crystal polarization grating that includes the active half-waveplate and the polarization grating;
the electronically-controllable light-steering mechanism includes a plurality of liquid crystal polarization gratings that includes the first liquid crystal polarization grating;
the liquid crystal material is a liquid crystal layer having liquid crystals that are attached to meta-surface components of a meta-surface layer, and wherein the electronically-controllable light-steering mechanism includes the liquid crystal layer and the meta-surface layer;
the application of voltage to the liquid crystal material includes varying the voltage applied so as to change the angle at which the light is reflected off of the meta-surface layer;
the electronically-controllable light-steering mechanism includes a microelectromechanical systems-based (MEMS-based) scanner;
the electronically-controllable light-steering mechanism includes a polarized beam splitter that includes an interface or a surface that permits light of a first linear polarization to pass through and reflects light of a second linear polarization, and wherein the first linear polarization is orthogonal to the second linear polarization;
the MEMS-based scanner reflects the light of the first linear polarization after the light passes through the polarized beam splitter, and wherein the light reflected off of the MEMS-based scanner then is reflected off of the interface or the surface of the polarized beam splitter and toward the image sensor;
the electronically-controllable light-steering mechanism includes a quarter-waveplate, and wherein the quarter-waveplate is positioned between the polarized beam splitter and the MEMS-based scanner so that the light of the first linear polarization passes through the polarized beam splitter and then passes through the quarter-waveplate, which then causes the light of the first linear polarization to be circularly-polarized;
the light that passes through the quarter-waveplate and that is circularly polarized then reflects off of the MEMS-based scanner and back through the quarter-waveplate, which then causes the light that is circularly polarized to be light of the second linear polarization, and wherein the light of the second linear polarization that passes through the polarized beam splitter after having passed through the quarter-waveplate is then reflected off of the interface or surface of the polarized beam splitter;
the electronically-steerable optical sensor includes optics, and wherein the optics are positioned between the polarized beam splitter and the image sensor such that the light reflected off of the interface or the surface of the polarized beam splitter is directed through the optics, which then refracts the light onto the image sensor;
the MEMS-based scanner is a single biaxial mirror that includes a surface off of which the light is reflected, wherein an angle with respect to a first axis of the surface of the MEMS-based scanner is controlled as a part of the scanning step, wherein an angle with respect to a second axis of the surface of the MEMS-based scanner is controlled as a part of the scanning step, and wherein the first axis is orthogonal to the second axis; and/or
the electronically-steerable optical sensor is incorporated into an autonomous vehicle (AV) system in an AV, wherein the overall image is combined with other sensor data obtained by the AV and used in determining an AV operation to be performed by the AV, and wherein the overall image is comprised of four or more sub-images including the first sub-image and the second sub-image.

According to another aspect, there is provided an electronically-steerable optical sensor. The electronically-steerable optical sensor includes: an optical lens; an electronically-controllable light-steering mechanism; an image sensor that observes light passing through the electronically-controllable light-steering mechanism and the optical lens; a controller having a processor that is communicatively coupled to memory, the memory storing computer instructions; wherein, when the processor executes the computer instructions, the electronically-steerable optical sensor: (i) captures a first sub-image having a first sub-image field of view using an image sensor of an electronically-steerable optical sensor; (ii) after capturing the first sub-image, steers light received at the electronically-steerable optical sensor using an electronically-controllable light-steering mechanism of the electronically-steerable optical sensor so as to obtain a second sub-image field of view; (iii) captures a second sub-image having the second sub-image field of view using the image sensor of the electronically-steerable optical sensor; and (iv) combines the first sub-image and the second sub-image so as to obtain the overall image.

According to various embodiments, the electronically-steerable optical sensor may further include any one of the following features or any technically-feasible combination of some or all of these features:
the electronically-controllable light-steering mechanism includes a liquid crystal material, and wherein the steering step includes controlling application of voltage to the liquid crystal material so as to steer the light in a particular manner; and/or
the electronically-controllable light-steering mechanism includes: a polarized beam splitter; a quarter-waveplate; and a microelectromechanical systems-based (MEMS-based) scanner, wherein the quarter-waveplate is arranged between the polarized beam splitter and the MEMS-based scanner such that light of a first linear polarization passes through the polarized beam splitter and through the quarter-waveplate, which causes the light of the first linear polarization to be circularly polarized, wherein the circularly polarized light then reflects off of the MEMS-based scanner and back through the quarter-waveplate so that the circularly polarized light is then converted to light of a second linear polarization, and wherein the first linear polarization is orthogonal to the second linear polarization.

### BRIEF DESCRIPTION OF THE DRAWINGS

One or more embodiments of the disclosure will hereinafter be described in conjunction with the appended drawings, wherein like designations denote like elements, and wherein:

FIG. 1 is a block diagram depicting an embodiment of an electronically-steerable optical sensor having an electronically-controllable light-steering mechanism;

FIG. 2 is a diagram illustrating a static field of view that is implemented by conventional image sensors;

FIG. 3 is a diagram illustrating a dynamic or steerable field of view that is implemented by various embodiments of the electronically-steerable optical sensor;

FIG. 4 is a diagram depicting an embodiment of an electronically-steerable optical sensor that uses liquid crystal polarization gratings (LCPGs);

FIG. 5 is a diagram depicting an embodiment of an electronically-steerable optical sensor that uses a meta-surface liquid crystal device;

FIG. 6 is a diagram depicting an embodiment of an electronically-steerable optical sensor that uses a microelectromechanical systems-based (MEMS-based) scanner;

FIG. 7 is a zoomed-in portion of the electronically-steerable optical sensor of FIG. 6;

FIG. 8 is a flowchart illustrating an embodiment of a method of obtaining an overall image that is constructed from multiple sub-images; and

FIG. 9 depicts an overall image that is comprised of a plurality of sub-images captured by an electronically-steerable optical sensor according to one embodiment.

### DETAILED DESCRIPTION

The system and method provided herein enable an overall image to be obtained by first capturing a plurality of sub-images having different fields of view and then combining the plurality of sub-images together to form the overall image. The sub-images are captured by an electronically-steerable optical sensor, which includes a stationary image sensor and that uses an electronically-controllable light-steering mechanism to steer light within a particular field of view toward the image sensor so that a sub-image having the particular field of view can be observed and recorded. According to some embodiments, the electronically-controllable light-steering mechanism can cause light to be deflected or reflected at a particular angle based on a state of the electronically-controllable light-steering mechanism, which is controllable through use of an electronic controller.

In one embodiment, the electronically-steerable optical sensor can be incorporated into an autonomous vehicle (AV) system of an autonomous vehicle. For example, the electronically-steerable optical sensor can be mounted on the vehicle in a manner such that the field of view of the electronically-steerable optical sensor faces an area outside the vehicle, such as an area in front or behind the vehicle. The electronically-steerable optical sensor can be used to obtain an overall image, such as through using the method below, and then the AV system of the AV can use the overall image for determining an AV operation to perform, such as to accelerate the AV or apply the brakes of the AV. In one embodiment, the overall image can be combined with other sensor information through use of sensor fusion technique(s).

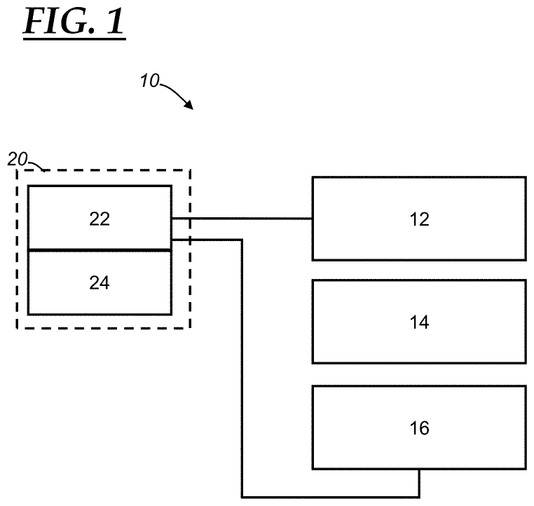

With reference to FIG. 1, there is shown an electronically-steerable optical sensor 10. The electronically-steerable optical sensor 10 includes an electronically-controllable light-steering mechanism 12, optics 14, and an image sensor 16. The electronically-controllable light-steering mechanism 12 (or “light-steering mechanism 12” for short) is used to steer incoming light so that the incoming light (or a portion thereof) is directed through the optics 14 and to the image sensor 16. A few, exemplary embodiments of the electronically-controllable light-steering mechanism 12 are described in more detail below with respect to FIGS. 4-7. The optics 14 can be any of a number of optical elements that can refract, deflect, or otherwise manipulate incoming light that is fed through the light-steering mechanism 12. The incoming light passes through the optics 14 and then to the image sensor 16. The optics 14 can include various types of lenses, such as those typically used with semiconductor charge-coupled devices (CCD) and/or complementary metal-oxide semiconductor (CMOS) cameras. The optics 14 can be selected based on the particular configuration being used, including the geometry, size, and arrangement of the components of the electronically-steerable optical sensor 10, such as the size and position of the image sensor 16 and/or the light-steering mechanism 12. The image sensor 16 can be a CCD or CMOS camera or image sensor (collectively referred to as “image sensor”). However, it should be appreciated that any suitable digital camera or image sensor can be used as the image sensor 16 and that any suitable optics can be used as the optics 14.

The electronically-steerable optical sensor 10 is coupled to a controller 20 that includes a processor 22 and memory 24. In one embodiment, the controller 20 is a part of the electronically-steerable optical sensor 10 and, in other embodiments, the controller 20 can be separate from the electronically-steerable optical sensor 10. The controller 20 may be communicatively coupled to the image sensor 16 such that images captured by the image sensor 16 can be processed by the processer 22 and/or stored in memory 24. The processed or raw image data that is obtained from the image sensor 16 can be stored into memory 24 of the controller 20. The processor 22 can also carry out the method discussed below, at least in some embodiments.

Also, in the illustrated embodiment, the processor 22 is electrically coupled to the light-steering mechanism 12 and may control the light-steering mechanism 12 through applying voltage to the light-steering mechanism 12, embodiments of which are described in more detail below. In some embodiments, the light-steering mechanism 12 can be controlled by another controller that is separate from the controller 20 that processes the images obtained by the image sensor 16. In such embodiments where multiple controllers are used, the controllers can be communicatively coupled to one another so as to coordinate their operation and/or to send data between each other. The discussion of the various types of processors that can be used as the processor 22 and memory that can be used as the memory 24 provided below is applicable to each of the controllers that may be used. That is, any controller discussed herein can include any of those types of processors and memory discussed below.

The processor 22 can be any type of device capable of processing electronic instructions including microprocessors, microcontrollers, host processors, controllers, vehicle communication processors, General Processing Unit (GPU), accelerators, Field Programmable Gated Arrays (FPGA), and Application Specific Integrated Circuits (ASICs), to cite a few possibilities. The processor 22 can execute various types of electronic instructions, such as software and/or firmware programs stored in memory 24, which enable the controller 20 to carry out various functionality. The memory 24 can be a non-transitory computer-readable medium or other suitable memory; these include different types of random-access memory (RAM) (including various types of dynamic RAM (DRAM) and static RAM (SRAM)), read-only memory (ROM), solid-state drives (SSDs) (including other solid-state storage such as solid state hybrid drives (SSHDs)), hard disk drives (HDDs), or other suitable computer medium that electronically stores information. In at least one embodiment, the memory 24 stores computer instructions that enable the processor 22 to carry out the method discussed below.

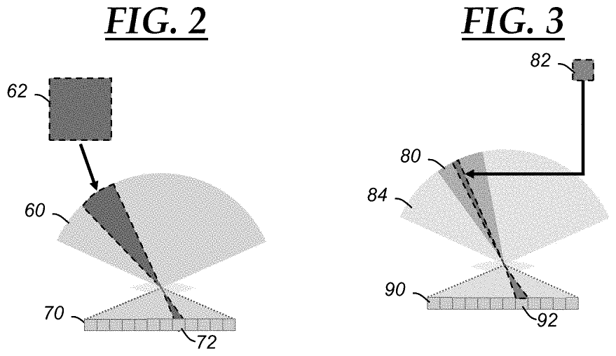

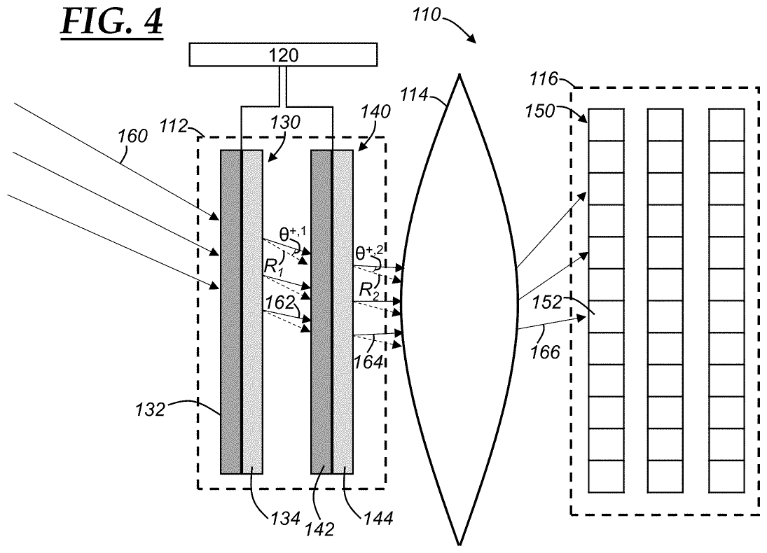

With reference to FIGS. 2-3, there is shown a diagram illustrating a static field of view 60 and a dynamic or steerable field of view 80. Many conventional image sensors have a static field of view 60, from which light is recorded as a pixel array 70. While this static field of view 60 can provide for a wide instantaneous field of view (i.e., the field of view at a given moment), the pixels of the images captured by the image sensor include a relatively large angular extent 62 for a given pixel 72. In these conventional systems, the instantaneous field of view is the same as the overall field of view. As shown in FIG. 3, the electronically-steerable image sensor 10 uses a narrower instantaneous field of view 80 to capture images by recording the captured light within a pixel array 90. Since the field of view is narrower or focused, for the same number of pixels in the array the angular extent 82 of each pixel 92 can be decreased and the resolution can be improved. The electronically-steerable optical sensor 10 can capture a plurality of sub-images each having a different field of view and then can combine these sub-images to create an overall image having an overall field of view 84. Thus, by using a narrower or focused instantaneous field of view that is steerable, higher resolution images can be captured while still maintaining a relatively wide field of view.

According to various embodiments including those of FIGS. 4-7, the angle or position of the instantaneous field of view 80 can be moved or controlled by the electronically-controllable light-steering mechanism 12 while the image sensor 16 is held stationary—that is, without having to move or angle the image sensor 16. In some conventional systems, the image sensor itself may be moved to face a different area so as to obtain a different field of view. According to at least some of the embodiments discussed herein, the image sensor 16 is held stationary while the electronically-controllable light-steering mechanism 12 steers light from the environment (or “incoming light”) in a particular direction (or at a particular angle) so that the image sensor can observe a range of field of views without having to be moved.

With reference to FIG. 4, there is shown a first embodiment of an electronically-steerable optical sensor 110. The electronically-steerable optical sensor 110 is an example of a solid state image sensor, which is a device that includes an image sensor that is able to obtain different fields of view without mechanically moving parts of the sensor. The electronically-steerable optical sensor 110 includes an electronically-controllable light-steering mechanism 112, optics 114, an image sensor 116, and a controller 120. The light-steering mechanism 112, the optics 114, the image sensor 116, and the controller 120 are analogous to the light-steering mechanism 12, the optics 14, the image sensor 16, and the controller 20 as discussed above, and that discussion is incorporated herein and not repeated for purposes of brevity. The electronically-controllable light-steering mechanism 112 (or “light-steering mechanism 112” for short) includes one or more liquid crystal polarized gratings (LCPGs) and, in the illustrated embodiment, a first LCPG 130 and a second LCPG 140 are shown, although any suitable number of LCPGs may be used. The LCPGs 130, 140 each include a half-waveplate 132, 142 and a polarization grating 134, 144. The half-waveplates 132, 142 are polarizers, and can be active half-waveplates that reverse the polarization of light when no voltage is applied (i.e., the “off-state”) and allow the light to pass through without changing the polarization when voltage is applied (i.e., the “on-state”). In some embodiments, the half-waveplates 132, 142 can be passive waveplates that reverse the polarization of the incident light. The half-waveplates 132, 142 are comprised of a birefringent material and, in at least one embodiment, are comprised of a liquid crystal material.

The polarization gratings 134, 144 deflect the light based on the polarization of the light, which may be a left-circular polarization (or left-hand polarization) or a right-circular polarization (or right-hand polarization). In one embodiment, the polarization gratings can be a nematic liquid crystal film that deflects or diffracts incoming light at a predefined angle. In at least one embodiment, the polarization gratings 134, 144 can be active polarization gratings, which are polarization gratings that can be turned on or turned off, or may be passive polarization gratings. When voltage is applied to an active polarization grating, the light passes through the polarization grating without being deflected or diffracted and, when voltage is not applied to the active polarization grating, light is deflected or diffracted at a predefined angle. The passive polarization gratings can deflect or diffract light and are not intended on being controlled by the application of voltage. The light that enters the polarization grating 134 is considered to be at a first reference line R₁ for the first LCPG 130 as indicated by the dashed-arrow. The polarization gratings 134, 144 can deflect the incoming light 160 at a deflection angle θ¹ (which is taken relative to the first reference line R₁), and the direction (e.g., positive (+) or negative (−)) of the deflection depends on the polarization of the incoming light 160 as it exits the first half-waveplate 132. Thus, a first predefined angle θ^{+,1} can be defined for left-hand polarized light and a second predefined angle θ^{-,1} for right-hand polarized light, where the predefined angle θ^{+,1} is the same as the second predefined angle θ^{-,1} except that the sign (e.g., + or −) is the opposite. For example, when the first predefined angle θ^{+,1} is 15° taken with respect to the first reference line R₁, then the second predefined angle θ^{-,1} is −15°. In one embodiment, when the light entering the polarization grating 134, 144 is left-hand polarized, then the polarization grating deflects the light at the first predefined angle θ^{+,1} and, when the light entering the polarization grating 134, 144 is right-hand polarized, then the polarization grating deflects the light at the second predefined angle θ^{-,1}.

As shown in FIG. 4, incoming light 160 passes through the first LCPG 130 including the first half-waveplate 132, which can be controlled such that the handedness of the polarization (e.g., right-hand polarization, left-hand polarization) of the incoming light 160 is reversed (e.g., when voltage is not applied) or maintained (e.g., when voltage is applied) as the light 160 travels through the first half-waveplate 132. The incoming light 160 as potentially modified by the first half-waveplate 132 then passes through the first polarization grating 134, which can deflect the light 160 at the predefined angle based on the polarization of the incoming light. Thus, the combination of the first half-waveplate 132 and the first polarization grating 134 allow the incoming light 160 to be deflected at the first predefined angle or the second predefined angle θ^{-,1} by electronically controlling (or activating/deactivating) the first half-waveplate 132. The light entering the first LCPG 130 can thus be deflected at the first predefined angle (for left-handed polarized light) or the second predefined angle θ^{-,1} (for right-handed polarized light). Thus, the first LCPG 130 enables the light to be directed in one of two directions, or at one of two angles (i.e., the first predefined angle θ^{+,1} or the second predefined angle θ^{-,1}).

When the light then exits the first LCPG 130 as indicated at 162, the light can then enter the second LCPG 140, which can deflect the light (or not) in the same manner. A second reference line R₂ can be designated to be an angle or orientation of the light 162 that is incident on the second LCPG 140. This light 162 can then be deflected again (or not) at a predefined angle so that the resulting light (indicated at 164) is at a first predefined angle θ^{+,2} or a second predefined angle θ^{-,2} relative to the second reference line R₂ depending on the polarization of the light, which (as discussed above) can be modified using the half-waveplate 142. Thus, the incoming light 160 can be deflected twice as shown in FIG. 4—first, the light 160 is deflected using the first LCPG 130 to produce the light 162 at the first predefined angle and then again at the second LCPG 140 to produce the light 164 that is deflected at an overall angle of θ^{+,1}+θ^{+,2}. As an example, the first predefined angle of the first LCPG 130 can be 5° and the first predefined angle θ^{+,2} of the second LCPG 140 can be 10°. The LCPGs 130, 140 can thus be controlled such that the incoming light 160 is deflected at an overall angle of 15°. Thus, by providing a plurality of LCPGs in a stacked arrangement (such as that shown in FIG. 4), the incoming light 160 can be directed in many different directions by the polarization gratings 134, 144 depending on the polarization of the light, which can be altered by the half-waveplates 132, 142. Also, in embodiments where an active polarization grating is used, voltage can be applied to the polarization gratings so as to allow the light through without deflection, which can enable the electronically-controllable light-steering mechanism 112 to direct the light according to a larger set of potential angles. Additionally, the deflection angle of the polarization gratings 134, 144 can be selected or predefined based on the particular application in which the mechanism 112 is to be used. Also, although the discussion above describes steering light with respect to a first dimension or axis (e.g., azimuth), a second set of LCPGs can be used and oriented in an orthogonal manner to that of the first set of LCPGs (e.g., the first LCPG 130 and the second LCPG 140) so that light can be steered with respect to the first axis and to a second axis (e.g., elevation) that is orthogonal to the first axis.

Once the light 160 is deflected (or not) by the electronically-controllable light-steering mechanism 112 to yield the light 164, this deflected light 164 passes through the optical lens 114, which then refracts the light to yield refracted light 166 that then is observed by the image sensor 116. As shown in FIG. 4, a first refracted light beam of the refracted light 166 is directed to a first pixel 152 of a first pixel array 150. Once a sub-image is captured at the images sensor 116, the controller 120 can cause the light-steering mechanism 112 to steer the incoming light in a manner such that the instantaneous field of view of the image sensor changes.

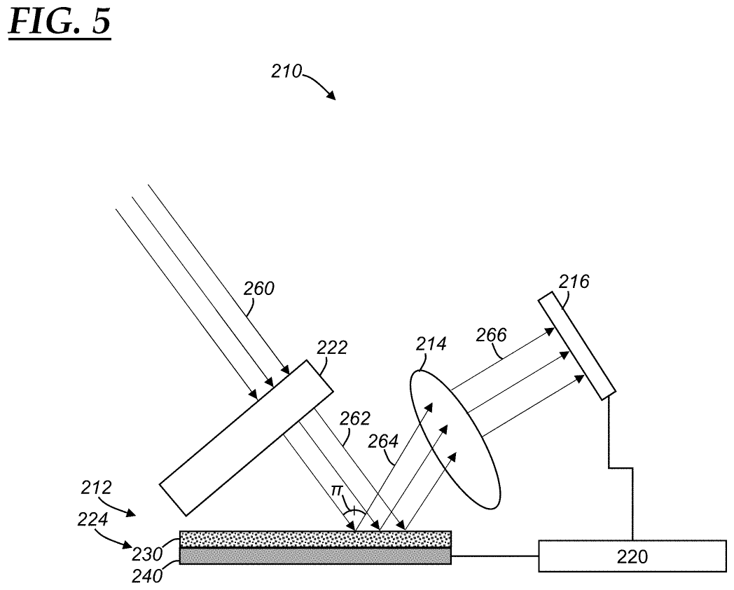

With reference to FIG. 5, there is shown a second embodiment of an electronically-steerable optical sensor 210, which is another example of a solid state image sensor. The electronically-steerable optical sensor 210 includes an electronically-controllable light-steering mechanism 212, optics 214, an image sensor 216, and a controller 220. The light-steering mechanism 212, the optics 214, the image sensor 216, and the controller 220 are analogous to the light-steering mechanism 12, the optics 14, the image sensor 16, and the controller 20 as discussed above and that discussion is incorporated herein and not repeated for purposes of brevity. The electronically-controllable light-steering mechanism 212 (or “light-steering mechanism 212” for short) includes a polarizer 222 and a meta-surface liquid crystal device 224 that includes a meta-surface layer 230 and a liquid crystal layer 240. The liquid crystal layer 240 includes a liquid crystal material (or liquid crystals) that are attached to meta-surface components of the meta-surface layer 230. Although the liquid crystal layer 240 is shown as being below the meta-surface layer 230, in at least some embodiments, the meta-surface layer 230 (or the meta-surface components) and the liquid crystal layer 240 can be embedded within the same layer and/or arranged in a different manner.

Voltage can be applied to the liquid crystal layer 240 by the controller 220 and, when applied, the liquid crystals then align (or change orientation) such that the light is reflected in a particular direction (or at a particular angle) as a function of the voltage applied. The incoming light 260 (i.e., light from the environment) passes through the polarizer 222. In at least one embodiment, the polarizer 222 causes linearly polarized light passing through to be circularly polarized. The polarizer 222 causes light 260 to be polarized in a manner such that the meta-surface liquid crystal device 224 can be operable to reflect the polarized light 262. The polarized light 262 is reflected by the meta-surface components of the meta-surface layer 230 to produce reflected light 264. The meta-surface components are selected or arranged so as to cause the polarized light 262 to exhibit Mie scattering. That is, these meta-surface components in the meta-surface layer 230 have a particle size similar to that (or on the order) of the wavelength λ of visible light, although this may not be necessary in all embodiments or implementations. For example, the meta-surface components can be sized as follows: 0.1*λ<meta-surface component<λ. The reflected light 264 then passes through the optics 214 to produce refracted light 266, which is then observed by the image sensor 216. As mentioned above, the reflection angle 7C can be adjusted based on or as a function of the voltage applied to the meta-surface liquid crystal device 224, which causes certain portions of incoming light to be steered toward the image sensor 216.

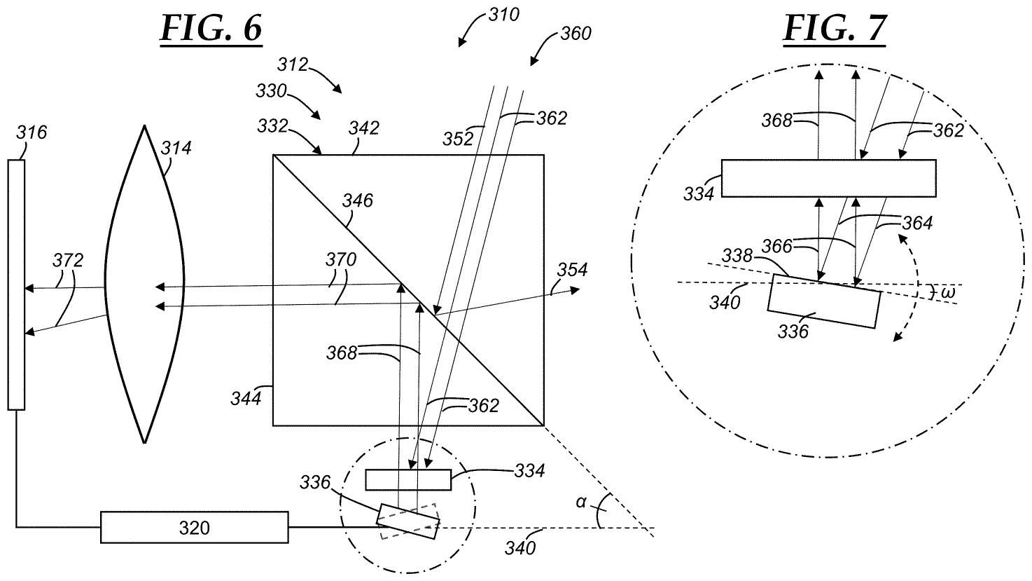

With reference to FIGS. 6-7, there is shown a third embodiment of an electronically-steerable optical sensor 310. The electronically-steerable optical sensor 310 includes an electronically-controllable light-steering mechanism 312, optics 314, an image sensor 316, and a controller 320. The light-steering mechanism 312, the optics 314, the image sensor 316, and the controller 320 are analogous to the light-steering mechanism 12, the optics 14, the image sensor 16, and the controller 20 as discussed above and that discussion is incorporated herein and not repeated for purposes of brevity. The electronically-controllable light-steering mechanism 312 (or “light-steering mechanism 312” for short) includes a microelectromechanical systems-based (MEMS-based) device 330 that includes a polarized beam splitter 332, a quarter-waveplate 334, and a MEMS-based scanner (or micro-scanning mirror) 336.

The polarized beam splitter 332 is a cube- (or cubic-) polarized beam splitter that includes a first right-angle triangular prism 342 (“first prism 342” for short) and a second right-angle triangular prism 344 (“second prism 344” for short) that engage one another along their hypotenuse surfaces to create a hypotenuse interface 346. The hypotenuse surface of at least one of the first prism 342 and the second prism 344 (and that forms the hypotenuse interface 346) is coated with one or more materials, such as aluminum, so that the polarized beam splitter 332 is operable as described below. The first prism 342 and the second prism 344 can be held together by an adhesive, such as a polyester, epoxy, or urethane-based adhesives, which can act as the coating or may be provided in addition to one or more coatings. In other embodiments, the polarized beam splitter 332 can be of a plate construction (or a plate beam splitter) and can include a plate-shaped surface that is disposed at a predefined angle α. In at least some embodiments, the polarized beam splitter 332 is arranged such that the hypotenuse interface 346 is disposed at 45° with respect to the reference line 340 of the MEMS-based scanner 336. In the case of the plate beam splitter, the predefined angle α that the plate is disposed at can be 45° with respect to a surface 338 of the MEMS-based scanner 336 when in a resting state. Of course, in other embodiments, the predefined angle α can be of another value. Other implementations besides the cube-shaped polarized beam splitter and the plate-shaped polarized beam splitter may be used as well. According to various embodiments, the polarized beam splitter 332 can include a coating of a particular thickness and/or a particular material so as to obtain the desired properties of the polarized beam splitter.

Light 360 from the environment passes through the first prism 342 of the polarized beam splitter 332, and then is incident on the hypotenuse interface 346. The hypotenuse interface 346 allows light of a first linear polarization (i.e., in this example, P-polarized light as indicated at 362) to pass through the hypotenuse interface 346 and reflects light of a second linear polarization (i.e., in this example, S-polarized light as indicated at 352) so that this light of the second linear polarization does not pass through. The light having the first linear polarization (referred to as first-linear-polarized light 362) passes through the second prism 344 and then is incident on the quarter-waveplate 334. This second-linear-polarization light 352 is reflected away as indicated at 354.

The quarter-waveplate 334 then causes the first-linear-polarized light 362 to be circularly polarized so as to produce circularly-polarized light 364 as shown in FIG. 7. The circularly-polarized light 364 is then reflected off of the MEMS-based scanner 336 at a particular angle, which can be adjusted by adjusting the MEMS-based scanner angle ω. The MEMS-based scanner angle is the angle between the surface of the MEMS-based scanner and a reference line 340. The reference line 340 is taken as extending along the surface 338 of the MEMS-based scanner 336 when positioned at a center position. The center position is a position of the MEMS-based scanner 336 in which the range of angles that the surface 338 can be tilted to a first side (e.g., to the left in FIG. 7) is the same as the range of angles that the surface 338 can be tilted to a second side (e.g., to the right in FIG. 7). The MEMS-based scanner 336 is a single biaxial mirror that can be angled in two directions or along two axes—that is, for example, the x-direction (or along the x-axis) and the y-direction (or along the y-axis). In other embodiments, the MEMS-based scanner 336 can be a uniaxial mirror that can be angled in one direction or along one axis. In yet another embodiment, the MEMS-based scanner 336 can include two uniaxial mirrors that can each be angled in one direction or along one axis, where the axis of the first uniaxial mirror is orthogonal or perpendicular to the second uniaxial mirror so as to allow the MEMS-based scanner 336 to be angled in two directions or along two axes. The MEMS-based scanner angle ω of the MEMS-based scanner 336 can be controlled using a variety of techniques, which can depend on the type of MEMS-based scanner 336 being used. The MEMS-based scanner angle ω can be driven or otherwise controlled according to a variety of mechanisms or principles, including electromagnetics, electrostatics, and piezo-electrics.

Once the circularly-polarized light 364 is reflected off of the MEMS-based scanner 336, the reflected circularly-polarized light 366 then passes through the quarter-waveplate 334 again, which causes the reflected circularly-polarized light 366 to be linearly-polarized in the second linear polarization (referred to as second-linear-polarized light 368), which is light that is linearly polarized orthogonal to the light of the first-linear-polarized light 362. That is, for example, the second-linear-polarized light 368 is S-polarized light. As discussed above, the hypotenuse interface 346 reflects light of the second linear polarization and, thus, the second-linear-polarized light 368 is reflected off of the hypotenuse interface 346 (as indicated at 370) and directed through the optics 314 to produce refracted light 372, which is then observed by the image sensor 316.

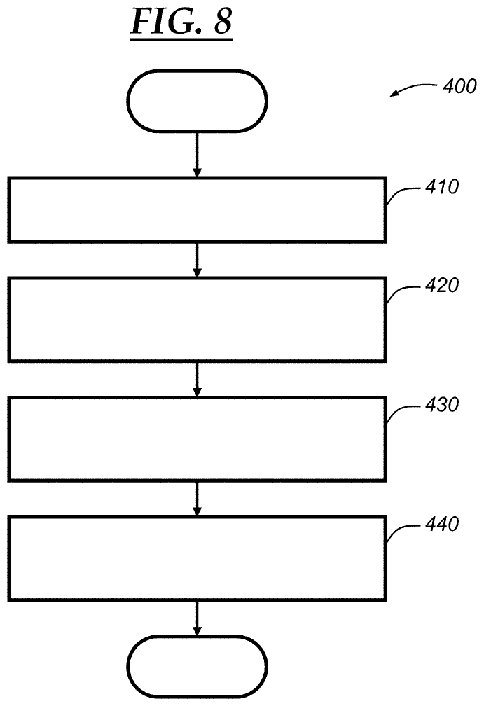

With reference to FIG. 8, there is shown an embodiment of a method 400 of obtaining an overall image that is constructed from multiple sub-images. The method 400 is carried out using the electronically-steerable optical sensor 10, which can be implemented according to any of the embodiments shown in FIGS. 4-7 and described above as electronically-steerable optical sensor 110, electronically-steerable optical sensor 210, and electronically-steerable optical sensor 310. In other embodiments, the method 400 can be carried out using other electronically-steerable optical sensors.

The method 400 begins with step 410, in which a first sub-image is captured using the electronically-steerable optical sensor. The first sub-image is an image that is captured by the electronically-steerable optical sensor 10 and includes a first sub-image field of view. The first sub-image field of view corresponds to the instantaneous field of view of the electronically-steerable optical sensor 10, such as that which is discussed above with respect to FIG. 3. The first sub-image can be processed by the processor 22 of the controller 20 and/or can be saved to memory 24 of the controller 20. The method 400 continues to step 420.

In step 420, the electronically-steerable optical sensor is operated to steer light so as to obtain a second sub-image field of view that is different from the first sub-image field of view. In at least some embodiments, the light is steered by applying voltage to the electronically-controllable light-steering mechanism of the sensor 10, such as to one or more polarization gratings of the LCPGs 130, 140 and/or to the liquid crystal layer 240. In one embodiment, the light can be steered by adjusting the MEMS-based scanner angle ω of the MEMS-based scanner 336.

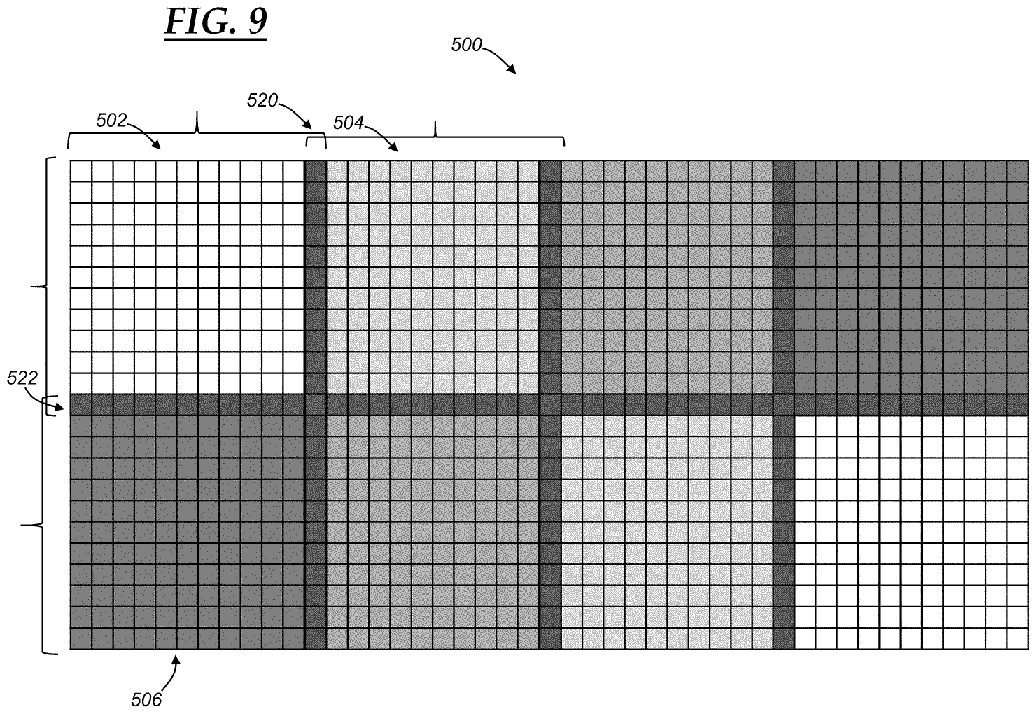

In some embodiments, the second sub-image field of view can include a portion of the first sub-image field of view. For example, with reference to FIG. 9, there is shown an overall image 500 having a first sub-image 502 and a second sub-image 504. The first sub-image 502 and the second sub-image 504 overlap one another as shown at overlapping portion 520. The overlapping portion 520, which is indicated by the dark portions between the sub-images 502 and 504, of the first sub-image 502 and the second sub-image 504 enable the method to combine the first sub-image 502 and the second sub-image 504. The overlapping portion can be small relative to the sub-images. For example, the second sub-image 504 can include an overlapping area that is one (1) pixel by the height of the second sub-image 504. In other embodiments when the first sub-image is arranged to the left or right of the second sub-image, the overlapping area can be two (2) to fifty (50) pixels wide.

As discussed above, the overall image can be made of an array of sub-images, and the array of sub-images can be stacked in one dimension or in two dimensions. For example, in a one-dimension sub-image array, the sub-images are arranged in one of the horizontal direction or the vertical direction. In a two-dimension sub-image array, the sub-images are arranged in both the horizontal direction and the vertical direction, such as that which is shown in FIG. 9—this array of the overall image 500 is a two (2) by four (4) sub-image array. The overall image can be comprised of any number of sub-images, such as, for example, four or more sub-images, eight or more sub-images, sixteen or more sub-images, etc. The number of sub-images can be set or adjusted based on the application in which the electronically-steerable optical sensor is used. The third sub-image 506 can be combined with the first sub-image 502 in the same manner as combining the first sub-image 502 and the second sub-image 504 as discussed above, except that the overlapping portion 522 extends in an orthogonal direction according to the second axis while the overlapping portion 520 extends according to the first axis. The method 400 continues to step 430.

In step 430, a second sub-image having a second sub-image field of view is captured using the electronically-steerable optical sensor. This step is similar to step 410 except that this step includes capturing an image after the field of view of the electronically-steerable optical sensor is steered so as to obtain the second sub-image field of view. Once the second sub-image is obtained, the second sub-image can be stored to memory 24 of the controller 20 and/or processed by the processor 22 of the controller 20. The method 400 continues to step 440.

In step 440, the first sub-image and the second sub-image are combined so as to obtain the overall image. The overall image includes a plurality of sub-images that extend in at least one direction. In some embodiments, the plurality of sub-images of the overall image extend in two directions, such as the two by four array of sub-images as shown in FIG. 9. The sub-images can be combined in any suitable manner, and can be done so according to various photo or image stitching techniques. In at least one embodiment, the sub-images can be stitched together as they are received, or all of the sub-images that are to constitute the overall image can first be obtained, and then the sub-images can be stitched together at once. The overall image can be saved to memory, such as memory 24 of the controller 20. The method 400 then ends.

In other embodiments, the method can be used to obtain a plurality of overall images so that a video can be obtained. For example, the method 400 can continuously be carried out to obtain a plurality of overall images, and these overall images can then be timestamped (e.g., through use of a clock of the controller 20). According to some embodiments, the electrically-steerable optical sensor 10 can use the electronically-controllable light-steering mechanism to quickly steer the light so as to obtain the different sub-image field of views that are then combined to create the overall image. In some embodiments, the electronically-controllable light-steering mechanism can be considered a solid state image sensor, which is a device that includes an image sensor that is able to obtain different fields of view without mechanically moving parts of the sensor. This enables the light to be steered quickly enough so that a video having a suitable frame rate can be achieved.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

What is claimed is:

1. A method of obtaining an overall image that is constructed from multiple sub-images, the method comprising the steps of:
capturing a first sub-image having a first sub-image field of view using an image sensor of an electronically-steerable optical sensor;
after capturing the first sub-image, steering light received at the electronically-steerable optical sensor using an electronically-controllable light-steering mechanism of the electronically-steerable optical sensor so as to obtain a second sub-image field of view;
capturing a second sub-image having the second sub-image field of view using the image sensor of the electronically-steerable optical sensor; and
combining the first sub-image and the second sub-image so as to obtain the overall image.

2. The method of claim 1, wherein the electronically-controllable light-steering mechanism includes a liquid crystal material.

3. The method of claim 2, wherein the steering step includes controlling application of voltage to the liquid crystal material so as to steer the light in a particular manner.

4. The method of claim 3, wherein the liquid crystal material is an active half-waveplate.

5. The method of claim 4, wherein the electronically-controllable light-steering mechanism includes a polarization grating arranged next to the active half-waveplate in a manner such that incoming light first passes through the active half-waveplate and then through the polarization grating.

6. The method of claim 5, wherein the electronically-controllable light-steering mechanism includes a first liquid crystal polarization grating that includes the active half-waveplate and the polarization grating.

7. The method of claim 6, wherein the electronically-controllable light-steering mechanism includes a plurality of liquid crystal polarization gratings that includes the first liquid crystal polarization grating.

8. The method of claim 3, wherein the liquid crystal material is a liquid crystal layer having liquid crystals that are attached to meta-surface components of a meta-surface layer, and wherein the electronically-controllable light-steering mechanism includes the liquid crystal layer and the meta-surface layer.

9. The method of claim 8, wherein the application of voltage to the liquid crystal material includes varying the voltage applied so as to change the angle at which the light is reflected off of the meta-surface layer.

10. The method of claim 1, wherein the electronically-controllable light-steering mechanism includes a microelectromechanical systems-based (MEMS-based) scanner.

11. The method of claim 10, wherein the electronically-controllable light-steering mechanism includes a polarized beam splitter that includes an interface or a surface that permits light of a first linear polarization to pass through and reflects light of a second linear polarization, and wherein the first linear polarization is orthogonal to the second linear polarization.

12. The method of claim 11, wherein the MEMS-based scanner reflects the light of the first linear polarization after the light passes through the polarized beam splitter, and wherein the light reflected off of the MEMS-based scanner then is reflected off of the interface or the surface of the polarized beam splitter and toward the image sensor.

13. The method of claim 12, wherein the electronically-controllable light-steering mechanism includes a quarter-waveplate, and wherein the quarter-waveplate is positioned between the polarized beam splitter and the MEMS-based scanner so that the light of the first linear polarization passes through the polarized beam splitter and then passes through the quarter-waveplate, which then causes the light of the first linear polarization to be circularly-polarized.

14. The method of claim 13, wherein the light that passes through the quarter-waveplate and that is circularly polarized then reflects off of the MEMS-based scanner and back through the quarter-waveplate, which then causes the light that is circularly polarized to be light of the second linear polarization, and wherein the light of the second linear polarization that passes through the polarized beam splitter after having passed through the quarter-waveplate is then reflected off of the interface or surface of the polarized beam splitter.

15. The method of claim 14, wherein the electronically-steerable optical sensor includes optics, and wherein the optics are positioned between the polarized beam splitter and the image sensor such that the light reflected off of the interface or the surface of the polarized beam splitter is directed through the optics, which then refracts the light onto the image sensor.

16. The method of claim 15, wherein the MEMS-based scanner is a single biaxial mirror that includes a surface off of which the light is reflected, wherein an angle with respect to a first axis of the surface of the MEMS-based scanner is controlled as a part of the scanning step, wherein an angle with respect to a second axis of the surface of the MEMS-based scanner is controlled as a part of the scanning step, and wherein the first axis is orthogonal to the second axis.

17. The method of claim 1, wherein the electronically-steerable optical sensor is incorporated into an autonomous vehicle (AV) system in an AV, wherein the overall image is combined with other sensor data obtained by the AV and used in determining an AV operation to be performed by the AV, and wherein the overall image is comprised of four or more sub-images including the first sub-image and the second sub-image.

18. An electronically-steerable optical sensor, comprising:
an optical lens;
an electronically-controllable light-steering mechanism;
an image sensor that observes light passing through the electronically-controllable light-steering mechanism and the optical lens;
a controller having a processor that is communicatively coupled to memory, the memory storing computer instructions;
wherein, when the processor executes the computer instructions, the electronically-steerable optical sensor:
captures a first sub-image having a first sub-image field of view using an image sensor of an electronically-steerable optical sensor;
after capturing the first sub-image, steers light received at the electronically-steerable optical sensor using an electronically-controllable light-steering mechanism of the electronically-steerable optical sensor so as to obtain a second sub-image field of view;
captures a second sub-image having the second sub-image field of view using the image sensor of the electronically-steerable optical sensor; and
combines the first sub-image and the second sub-image so as to obtain the overall image.

19. The electronically-steerable optical sensor of claim 18, wherein the electronically-controllable light-steering mechanism includes a liquid crystal material, and wherein the steering step includes controlling application of voltage to the liquid crystal material so as to steer the light in a particular manner.

20. The electronically-steerable optical sensor of claim 18, wherein the electronically-controllable light-steering mechanism includes: a polarized beam splitter; a quarter-waveplate; and a microelectromechanical systems-based (MEMS-based) scanner, wherein the quarter-waveplate is arranged between the polarized beam splitter and the MEMS-based scanner such that light of a first linear polarization passes through the polarized beam splitter and through the quarter-waveplate, which causes the light of the first linear polarization to be circularly polarized, wherein the circularly polarized light then reflects off of the MEMS-based scanner and back through the quarter-waveplate so that the circularly polarized light is then converted to light of a second linear polarization, and wherein the first linear polarization is orthogonal to the second linear polarization.
